(19) United States
(12) Patent Application Publication
(10) Pub. No.: US 2025/0238291 A1
(43) Pub. Date: Jul. 24, 2025

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: MASAAKI SATO, Kanagawa (JP)

(21) Appl. No.: 19/034,011

(22) Filed: Jan. 22, 2025

(30) Foreign Application Priority Data
Jan. 24, 2024 (JP) 2024-008779

(51) Int. Cl. G06F 9/54

(52) U.S. Cl. CPC G06F 9/542

(57) ABSTRACT

Provided is an information processing apparatus configured to execute a Web browser and an event handler implemented on the Web browser, the information processing apparatus including: at least one memory and at least one processor which function the event handler as: a generation unit configured to generate a change event in a case where a predetermined event is notified from a browser engine of the Web browser.

### BACKGROUND

### Field of the Invention

The present disclosure relates to an information processing apparatus, a control method of the information processing apparatus, and a storage medium.

### Description of the Related Art

In general, there is a multifunction peripheral (MFP, hereinafter referred to as an image formation apparatus) provided with a scanner, a printer, and the like that also includes a Web browser. The Web browser uses a browser engine to execute and display a script (in general, referred to as JavaScript (registered trademark)) obtained from a server. The browser engine can generate a change event after input to an input field being displayed on the Web browser is completed and focusing out of the input field. In a case where the browser engine generates the change event, the Web browser executes JavaScript corresponding to the change event. As an example, JavaScript provides a function of converting a character inputted to the input field from a lower case to an upper case, and thus the convenience of the Web browser is enhanced.

Additionally, there are multiple browser engines of different types or versions as the browser engine used by the Web browser. Therefore, it is possible to change the browser engine of the Web browser.

Japanese Patent Laid-Open No. 2008-225802 (PTL 1) discloses a method of automatically generating and complementing input information by detecting a specific event for an input field on a Web browser.

Some of the browser engines do not have a configuration to generate the change event after the input to the input field being displayed on the Web browser is completed and focusing out of the input field. In a case where the browser engine of such a configuration is introduced to the information input apparatus in PTL 1, there is a problem that JavaScript corresponding to the change event is not executed even in a case where the specific event is detected.

### SUMMARY

An information processing apparatus according to an aspect of the present disclosure is an information processing apparatus configured to execute a Web browser and an event handler implemented on the Web browser, the information processing apparatus including: at least one memory and at least one processor which function the event handler as: a generation unit configured to generate a change event in a case where a predetermined event is notified from a browser engine of the Web browser.

Further features of the present invention will become apparent from the following description of exemplary embodiments with reference to the attached drawings.

### BRIEF DESCRIPTION OF THE DRAWINGS

FIG. 1 is an overall view illustrating an example of a system;

FIG. 2 is a block diagram illustrating an example of a configuration of an image formation apparatus;

FIG. 3 is a diagram illustrating an example of a program configuration of a Web browser;

FIGS. 4A to 4C are diagrams illustrating an example of a screen displayed by the Web browser;

FIG. 5 is a sequence diagram illustrating an example of a flow in which a browser engine generates a change event;

FIG. 6 is a sequence diagram illustrating an example of a flow in which an event handler generates the change event;

FIG. 7 is a flowchart illustrating an example of processing executed by the event handler;

FIG. 8 is a flowchart illustrating an example of processing executed by a browser app;

FIG. 9 is a diagram illustrating an example of a program configuration of the Web browser; and

FIG. 10 is a flowchart illustrating an example of processing executed by the event handler.

### DESCRIPTION OF THE EMBODIMENTS

Preferred embodiments of the present disclosure are described below in detail with reference to the appended drawings. Note that, the following embodiments are not intended to limit the matters of the present disclosure, and not all the combinations of the characteristics described in the following embodiments are necessarily essential for the solution provided by the present disclosure. Note that, the same configurations are described with the same reference numerals provided.

### First Embodiment

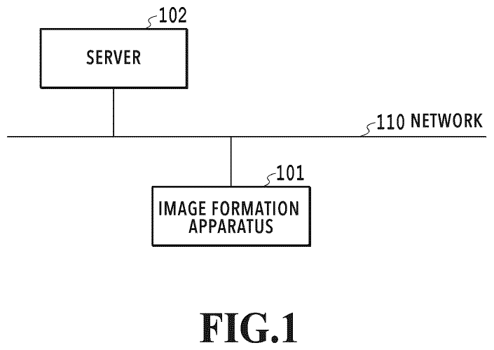

FIG. 1 is an overall view illustrating an example of a system in a first embodiment. The present system includes an image formation apparatus 101 and a server 102. The image formation apparatus 101 and the server 102 are connected communicably to each other via a network 110. The server 102 can use URLs of multiple different access destinations.

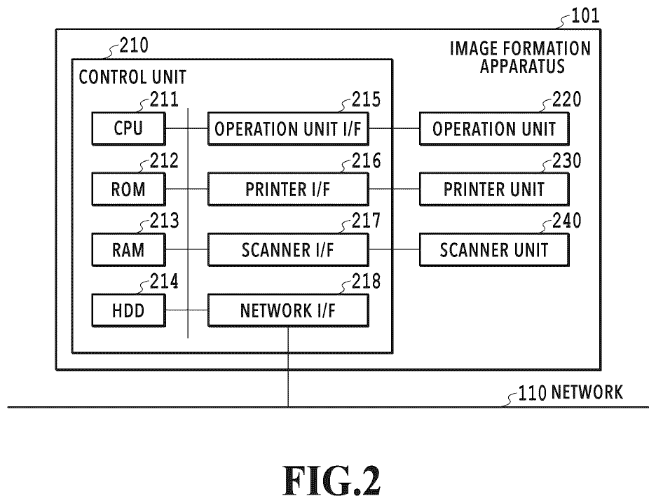

FIG. 2 is a block diagram illustrating an example of a configuration of the image formation apparatus 101. The image formation apparatus 101 includes a control unit 210, an operation unit 220, a printer unit 230, and a scanner unit 240. The control unit 210 includes a CPU 211, a ROM 212, a RAM 213, an HDD 214, an operation unit interface (hereinafter, referred to as I/F) 215, a printer I/F 216, a scanner I/F 217, and a network I/F 218.

The control unit 210 including the CPU 211 controls an operation of overall the image formation apparatus 101. The CPU 211 implements various controls such as reading control and transmission control by reading out a control program stored in the ROM 212 to the RAM 213 and executing the read out control program. The RAM 213 is a main memory of the CPU 211 and is used as a temporal storage region such as a working area. The HDD 214 stores image data, various programs, and the like.

The operation unit I/F 215 connects the operation unit 220 and the control unit 210 to each other. In the operation unit 220, a liquid crystal display unit having a touch panel function and various keys are provided. The printer I/F 216 connects the printer unit 230 and the control unit 210 to each other. The image data that should be printed by the printer unit 230 is transferred from the control unit 210 to the printer unit 230 via the printer I/F 216. In the printer unit 230, the transferred image data is printed on a printing medium.

The scanner I/F 217 connects the scanner unit 240 and the control unit 210 to each other. The scanner unit 240 generates the image data by reading an image on an original document and inputs the image data to the control unit 210 via the scanner I/F 217.

The network I/F 218 connects the control unit 210 to the network 110. A user inputs a URL of the server 102 to access into an input unit of a Web browser displayed on the liquid crystal display unit of the operation unit 220. The Web browser transmits a request to the server 102 of an IP address obtained from the inputted URL via the network I/F 218. In a case where the server 102 receives the request, the server 102 transmits a response of corresponding Web contents to the Web browser. In general, the Web contents corresponding to the response is described by using Hyper Text Markup Language (HTML), Cascading Style Sheets (CSS), JavaScript (registered trademark), and the like.

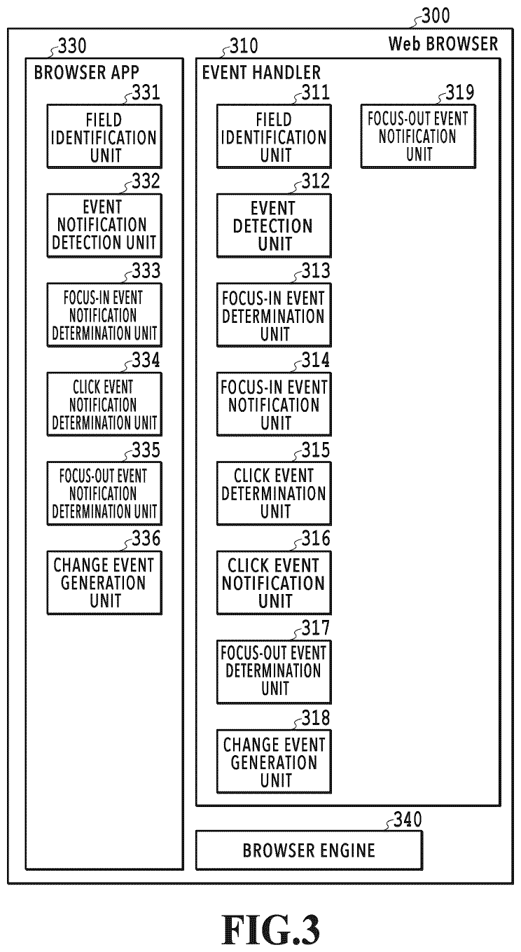

FIG. 3 is a diagram illustrating an example of a program configuration of a Web browser 300 stored in the image formation apparatus 101 in the present embodiment. The Web browser 300 includes an event handler 310, a browser app 330, and a browser engine 340. The event handler 310 is a program that can be called from the browser engine 340 and is a program to perform specific processing on a predetermined event. Additionally, the event handler 310 is a program implemented on the Web browser. The browser engine 340 performs processing of managing a user interface (UI) and parsing the obtained Web contents. The browser app 330 performs processing of displaying the parsed Web contents received from the browser engine 340.

The event handler 310 includes a field identification unit 311, an event detection unit 312, a focus-in event determination unit 313, a focus-in event notification unit 314, a click event determination unit 315, and a click event notification unit 316. The event handler 310 includes a focus-out event determination unit 317, a change event generation unit 318, and a focus-out event notification unit 319.

The browser app 330 includes a field identification unit 331, an event notification determination unit 332, a focus-in event notification determination unit 333, a click event notification determination unit 334, a focus-out event notification determination unit 335, and a change event generation unit 336.

In a case where an event for an input field being displayed on the Web browser 300 is notified from the browser engine 340, the field identification unit 311 identifies the input field as a target. The event detection unit 312 detects that the event registered in advance in the browser engine 340 is notified. As the event to be detected, a focus-in event, a click event, and a focus-out event are described as an example.

Here, in the present specification, “focus-in” indicates a state of focusing the input field (for example, a state in which a mouse pointer and the like enter the input field). Additionally, “click” indicates a state in which the focused input field is selected. A value of the input field is set with the user inputting a value into the input field during the selected state. Moreover, “focus-out” indicates a state in which the input field is not focused anymore after the user completes the input into the input field.

The focus-in event determination unit 313 determines whether the detected event is the focus-in event. The focus-in event notification unit 314 notifies the browser app 330 of the focus-in event.

The click event determination unit 315 determines whether the detected event is the click event. The click event notification unit 316 notifies the browser app 330 of the click event.

The focus-out event determination unit 317 determines whether a detected event is the focus-out event. The change event generation unit 318 generates a change event. Note that, to generate the change event is expressed as to fire the change event in some cases. With the change event being generated, a not-illustrated JavaScript engine executes JavaScript corresponding to the change event included in the Web contents already obtained by the browser app 330. The focus-out event notification unit 319 notifies the browser app 330 of the focus-out event. Note that, details of a configuration of the browser app 330 are described later.

### Example of Browser Engine Generating Change Event

In the present embodiment, although an example of processing in a case where the browser engine does not generate the change event is described later, for the sake of easy understanding, first, an example in which the browser engine generates the change event is described as a comparative example.

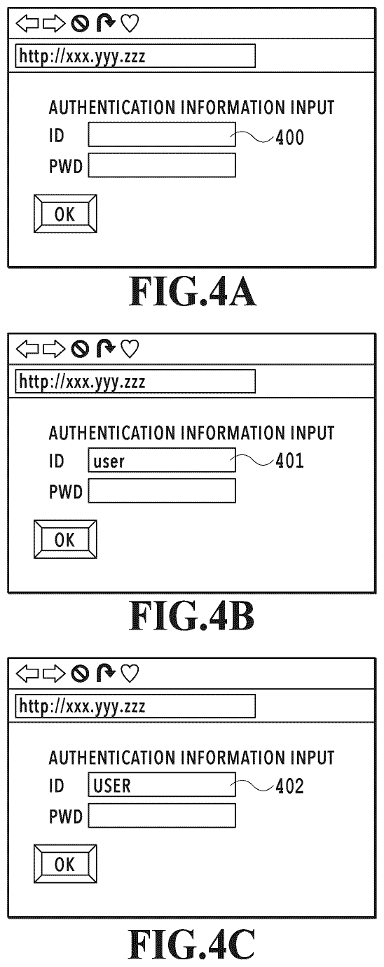

FIGS. 4A to 4C are diagrams illustrating an example of a screen displayed by the Web browser 300 of the image formation apparatus 101. An example in which the browser engine generates the change event is described with reference to FIGS. 4A to 4C. FIG. 4A is a diagram illustrating a UI screen displayed after the Web contents are obtained from the server 102. In FIG. 4A, an input field 400 of an ID and the like into which authentication information for user authentication is inputted. The input field 400 is in a blank state in a case where the Web contents are obtained (on an initial screen). The user can access a desired page by inputting ID information set in advance into the input field 400, for example. In a case where the user inputs the ID information, once the mouse pointer enters the input field 400, or the input field 400 is pressed by the user, the browser engine notifies the browser app of the event.

FIG. 4B is a diagram illustrating the UI screen in a case where the ID information is inputted in the input field in FIG. 4A. FIG. 4B illustrates a state in which the user inputs “user” in lower case in an input field 401 as the ID information. In a case where the input is completed, and the input field 401 is not focused anymore, the browser engine generates the change event. The Web browser 300 executes JavaScript corresponding to the change event by generating the change event. In a case where JavaScript is executed, the character in the input field 401 is converted from lower case into upper case. Note that, the Web contents include JavaScript for the conversion from lower case to upper case in accordance with the completion of the input into the input field and the generation of the change event after focusing out.

FIG. 4C is a diagram illustrating the UI screen after the input of the ID information into the input field 401 in FIG. 4B is completed, focusing out of the input field 401, and then the change event is generated. A state in which a character inputted in an input field 402 is converted into upper case “USER” is illustrated.

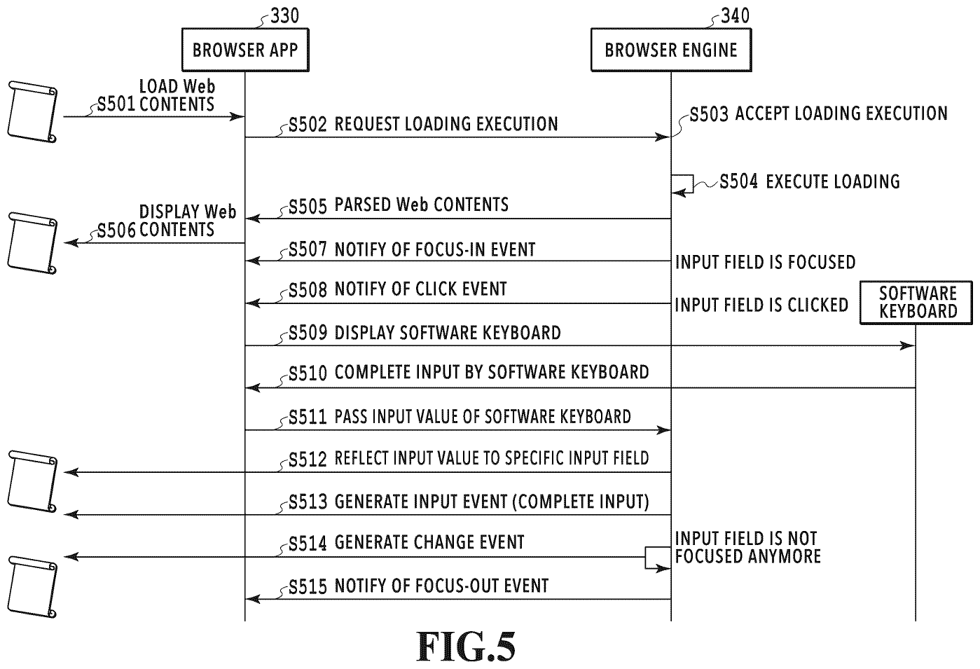

As described above, the browser engine configured to generate the change event after the input into the input field being displayed on the Web browser 300 is completed and focusing out is described. FIG. 5 is a sequence diagram illustrating an example of a flow in which the browser engine configured as above generates the change event. Processing performed by the browser engine that generates the change event and the browser app is described with reference to FIG. 5.

In S501, the browser app obtains the Web contents from the server. In S502, the browser app requests the browser engine to execute loading of the Web contents obtained in S501. In S503, the browser engine accepts the loading execution of the Web contents from the browser app.

In S504, the browser engine executes the loading of the Web contents. In S505, the browser engine returns a rendering result (parsed Web contents) of the loaded Web contents to the browser app. In S506, the browser app displays the Web contents on the liquid crystal display unit of the operation unit 220.

In S507, in a case where the browser engine detects an operation to focus in the input field and the like displayed on the Web browser 300 by the user, the browser engine notifies the browser app of the focus-in event.

In S508, in a case where the browser engine detects an operation to click the input field and the like displayed on the Web browser 300 by the user, the browser engine notifies the browser app of the click event.

In S509, in a case where the browser app receives the notification of the click event, the browser app performs processing of displaying a software keyboard. In S510, the user performs an operation to input an input value into the input field displayed by the browser app by using the software keyboard.

In S511, the browser app passes the input value of the software keyboard to the browser engine. In S512, the browser engine reflects the input value to the input field. Then, in S513, once the input operation by the user is completed, the browser engine generates an input completion event.

In S514, in a case where the browser engine detects an operation to focus out of the input field and the like displayed on the Web browser 300 by the user after S513, the browser engine generates the change event. Then, in S515, the browser engine notifies the browser app of the focus-out event. Note that, the processing in which the browser engine generates the change event is usually performed in a case where the focus-out event is detected.

As described above, in a case where the focus-out event is detected, the browser engine generates the change event. Thus, processing of changing the value inputted in the input field from lower case to upper case is performed, for example.

### Example of Browser Engine Not Generating Change Event

Some of browser engines are not configured to generate the change event after focusing out. Next, processing of the browser engine that is not configured to generate the change event after the input into the input field being displayed on the Web browser 300 is completed and focusing out is described with reference to FIG. 4.

As illustrated in FIG. 4B, even in a case where the user inputs “user” into the input field 401 in lower case, the browser engine does not generate the change event. Since no change event is generated, the Web browser 300 does not execute JavaScript corresponding to the change event. Therefore, the characters are not converted into “USER” in upper case as illustrated in FIG. 4C, and it is a state in which the characters in the input field 401 remain in lower case.

### Example of Event Handler Generating Change Event

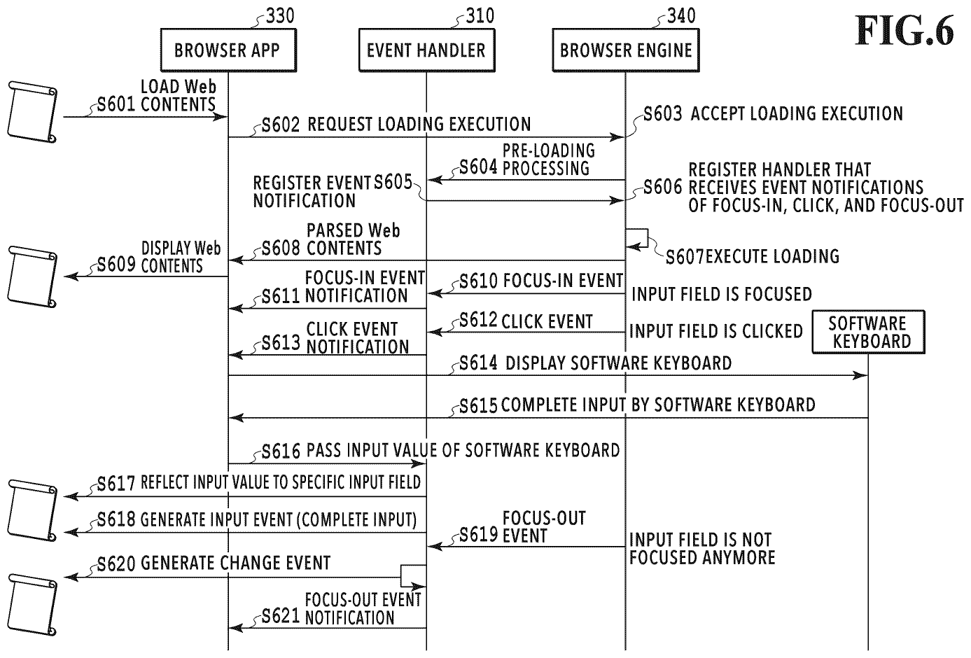

FIG. 6 is a sequence diagram illustrating an example of a flow in which the event handler 310 generates the change event in the present disclosure. Processing performed by the event handler 310 generating the change event, the browser engine 340, and the browser app 330 is described with reference to FIG. 6.

In S601, the browser app 330 obtains the Web contents from the server. In S602, the browser app 330 requests the browser engine 340 to execute loading of the Web contents obtained in S601. In S603, the browser engine 340 accepts the loading execution of the Web contents from the browser app 330.

In S604, the browser engine 340 executes pre-loading processing before executing the loading of the Web contents and calls the event handler 310. In general, the pre-loading processing has been known as processing in S605 and S606 performed by the event handler 310 and the browser engine 340, respectively. More specifically, a description about JavaScript is included in the Web contents to function the browser engine 340 as the event handler 310. In the pre-loading processing, the browser engine 340 calls the event handler 310 based on the description.

In S605, the called event handler 310 registers notifications of the events of focus-in, click, and focus-out. That is, the event handler 310 registers a function to receive the notification of each event out of multiple functions described in a file of predetermined JavaScript arranged in a specific file path. Note that, the file of the predetermined JavaScript can be read on the memory by the browser engine and can be prepared as an extension function of the browser engine.

In S606, the browser engine 340 registers a handler that receives the notifications of the events of focus-in, click, and focus-out. That is, after receiving the function registered by the event handler 310, the browser engine 340 reads the file of the predetermined JavaScript on the memory and registers the function as the handler that notifies the event handler 310 of the events.

In S607, the browser engine 340 executes the loading of the Web contents. In S608, the browser engine 340 returns a rendering result (parsed Web contents) of the loaded Web contents to the browser app 330. In S609, the browser app 330 displays the Web contents on the liquid crystal display unit of the operation unit 220.

In S610, in a case where the browser engine 340 detects an operation to focus in the input field and the like displayed on the Web browser 300 by the user, the browser engine 340 notifies the event handler 310 of the focus-in event. In S611, in a case where the event handler 310 receives the notification of the focus-in event in S610, the event handler 310 notifies the browser app 330 of the focus-in event.

In S612, in a case where the browser engine 340 detects an operation to click the input field and the like displayed on the Web browser 300 by the user, the browser engine 340 notifies the event handler 310 of the click event. In S613, in a case where the event handler 310 receives the notification of the click event in S612, the event handler 310 notifies the browser app 330 of the click event.

In S614, in a case where the browser app 330 receives the notification of the click event, the browser app 330 performs processing of displaying the software keyboard. In S615, the user performs the operation to input the input value into the input field displayed by the browser app 330 by using the software keyboard.

In S616, the browser app 330 passes the input value of the software keyboard to the event handler 310. In S617, the event handler 310 reflects the input value to the input field. Then, in S618, once the input operation by the user is completed, the event handler 310 generates the input completion event.

In S619, in a case where the browser engine 340 detects an operation to focus out of the input field and the like displayed on the Web browser 300 by the user after S618, the browser engine 340 notifies the event handler 310 of the focus-out event.

In S620, in a case where the event handler 310 receives the notification of the focus-out event in S619, the event handler 310 generates the change event. In S621, the event handler 310 notifies the browser app 330 of the focus-out event. In FIG. 5, it is described that the processing in which the browser engine generates the change event is usually performed in a case where the focus-out event is detected. Likewise, the processing in which the event handler 310 generates the change event is also performed in a case where the focus-out event is detected, and thus it is possible to maintain the compatibility with the browser engine.

Thus, even in a case of the browser engine that is not configured to generate the change event, it is possible to change the input value in the input field with the event handler generating the change event.

### Event Notification Processing by Event Handler While Displaying Web Contents

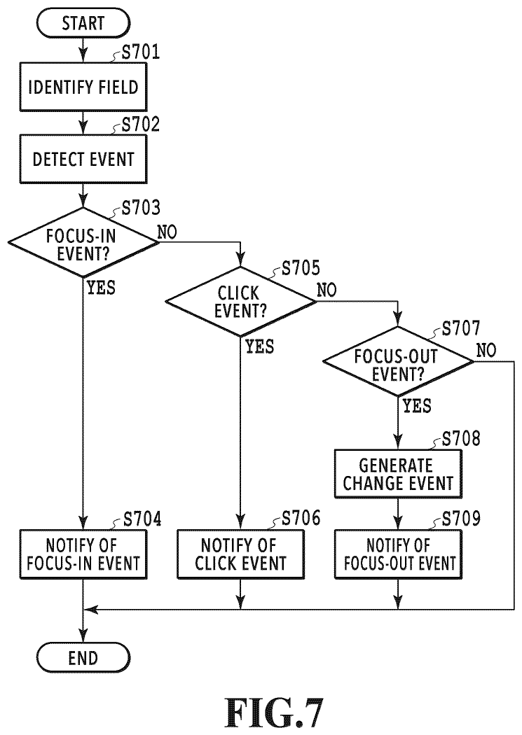

FIG. 7 is a flowchart illustrating an example of processing executed by the event handler 310. Processing in which the event handler 310 detects an event of a specific input field and notifies of the event while the browser app 330 of the image formation apparatus 101 in the present embodiment displays the Web contents is described with reference to FIG. 7. The processing illustrated in FIG. 7 is implemented with the CPU 211 of the image formation apparatus 101 reading out the program stored in the ROM 212 to the RAM 213 to execute. Note that, a part of or all the functions of steps in FIG. 7 may be implemented by hardware such as an ASIC or an electronic circuit. The sign “S” in a description of each processing means that it is a step in the flowchart (hereinafter, the same applies to flowcharts in the present specification). The processing illustrated in FIG. 7 is started in a case where the user performs the operation on the input field being displayed on the browser app 330 and thereafter the event handler 310 receives event information corresponding to the operation from the browser engine 340. The event information includes information indicating the input field as the target of the operation, information indicating the event, and the like, or includes the value inputted in the input field. Hereinafter, the event information received from the browser engine 340 is referred to as a notified event.

In S701, the CPU 211 uses the field identification unit 311 to identify the operated target input field from the event notified from the browser engine 340. Thereafter, the CPU 211 proceeds to processing in S702.

In S702, the CPU 211 uses the event detection unit 312 to detect the event as the operation performed on the input field from the event notified from the browser engine 340. Thereafter, the CPU 211 proceeds to processing in S703.

In S703, the CPU 211 uses the focus-in event determination unit 313 to determine whether the event detected in S702 is the focus-in event. If it is determined that the event detected in S702 is the focus-in event (Yes), the CPU 211 proceeds to processing in S704, and if it is determined that the event detected in S702 is not the focus-in event (No), the CPU 211 proceeds to processing in S705. In S704, the CPU 211 uses the focus-in event notification unit 314 to notify the browser app 330 of the focus-in event and ends the processing illustrated in FIG. 7.

In S705, the CPU 211 uses the click event determination unit 315 to determine whether the event detected in S702 is the click event. If it is determined that the event detected in S702 is the click event (Yes), the CPU 211 proceeds to processing in S706, and if it is determined that the event detected in S702 is not the click event (No), the CPU 211 proceeds to processing in S707. In S706, the CPU 211 uses the click event notification unit 316 to notify the browser app 330 of the click event and ends the processing illustrated in FIG. 7.

In S707, the CPU 211 uses the focus-out event determination unit 317 to determine whether the event detected in S702 is the focus-out event. If it is determined that the event detected in S702 is the focus-out event (Yes), the CPU 211 proceeds to processing in S708, and if it is determined that the event detected in S702 is not the focus-out event (No), the CPU 211 ends the processing illustrated in FIG. 7.

In S708, the CPU 211 uses the change event generation unit 318 to generate the change event and proceeds to processing in S709. In S709, the CPU 211 uses the focus-out event notification unit 319 to notify the browser app 330 of the focus-out event and ends the processing illustrated in FIG. 7.

### Example of Application

An example of application of the above-described event notification processing by the event handler is described with reference to FIGS. 4B and 4C and the flowchart in FIG. 7. In the present example of application, a case where the event of focusing out of the input field 401 illustrated in FIG. 4B is notified from the browser engine 340 is described.

In S701 in FIG. 7, the CPU 211 uses the field identification unit 311 to identify the operated target input field from the event notified from the browser engine 340. That is, in a case where the user performs the operation of focusing out on the input field 401 illustrated in FIG. 4B, the field identification unit 311 identifies the input field notified from the browser engine 340 as the input field as the target of the operation.

In S702, the CPU 211 uses the event detection unit 312 to detect the event as the operation performed on the input field from the notified event from the browser engine 340. In this process, the event handler 310 is notified of the focus-out event from the browser engine 340 as the event.

In S703, the CPU 211 uses the focus-in event determination unit 313 to determine whether the event detected in S702 is the focus-in event. In this case, the notified event is an event other than focus-in; for this reason, the CPU 211 proceeds to processing in S705.

In S705, the CPU 211 uses the click event determination unit 315 to determine whether the event detected in S702 is the click event. In this case, the notified event is an event other than click; for this reason, the CPU 211 proceeds to processing in S707.

In S707, the CPU 211 uses the focus-out event determination unit 317 to determine whether the event detected in S702 is the focus-out event. In this case, the notified event is focus-out; for this reason, the CPU 211 proceeds to processing in S708.

In S708, the CPU 211 uses the change event generation unit 318 to generate the change event and proceeds to processing in S709. In a case where the change event is generated, processing of converting “user” in lower case that is inputted in the input field 401 illustrated in FIG. 4B into “USER” in upper case in the input field 402 illustrated in FIG. 4C is executed. In S709, the CPU 211 uses the focus-out event notification unit 319 to notify the browser app 330 of the focus-out event.

According to the present embodiment, the event handler generates the change event in a case where the focus-out event is detected, neither the focus-in event nor the click event. Since the event handler generates the change event, JavaScript corresponding to the change event is executed, and thus the input character in the input field is converted from lower case into “USER” in upper case. Thus, a problem that the change event is not generated that is associated with a change in the browser engine is solved, and therefore it is possible to secure the convenience of the browser.

### Second Embodiment

In the first embodiment, an example in which the change event is generated in a case where the event handler 310 detects the focus-out event is described. In the present embodiment, an example in which the browser app 330 determines the event notification received from the event handler 310 and generates the change event is described.

### Software Configuration Diagram of Image Formation Apparatus 101

A program configuration of the Web browser in the present embodiment is a configuration similar to that in the first embodiment as illustrated in FIG. 3. Details of the browser app 330 are described with reference to FIG. 3.

The field identification unit 331 has a configuration similar to that of the field identification unit 311. The event notification determination unit 332 detects the event notification notified by the event handler 310. The detected event notification is the focus-in event notification, the click event notification, and the focus-out event notification. The focus-in event notification determination unit 333 determines whether the event notification from the event handler 310 is the focus-in event notification and returns a determination result. The click event notification determination unit 334 determines whether the event notification from the event handler 310 is the click event and returns a determination result. The focus-out event notification determination unit 335 determines whether the event notification from the event handler 310 is the focus-out event and returns a determination result. The change event generation unit 336 has a configuration similar to that of the change event generation unit 318.

### Event Notification Reception Processing by Browser App While Displaying Web Contents

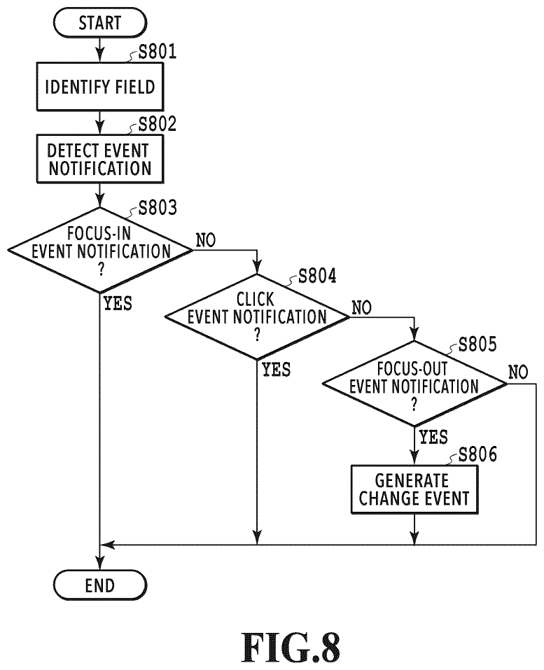

FIG. 8 is a flowchart illustrating an example of processing executed by the browser app 330. Processing in which the Web browser detects an event of a specific input field, and the browser app 330 of the image formation apparatus 101 in the present embodiment receives the event notification from the event handler 310 while displaying the Web contents is described with reference to FIG. 8. The processing illustrated in FIG. 8 is implemented with the CPU 211 of the image formation apparatus 101 reading out the control program stored in the memory such as the ROM 212 to the RAM 213 to execute. The processing illustrated in FIG. 8 is started in a case where the event is notified from the browser engine 340 to the browser app 330.

In S801, the CPU 211 uses the field identification unit 331 to identify the operated target input field from the event notified from the browser engine 340. Thereafter, the CPU 211 proceeds to processing in S802.

In S802, the CPU 211 uses the event notification determination unit 332 to detect the event notification received from the event handler 310. Thereafter, the CPU 211 proceeds to processing in S803.

In S803, the CPU 211 uses the focus-in event notification determination unit 333 to determine whether the event notification detected in S802 is the focus-in event notification. If it is determined that the event notification is the focus-in event notification (Yes), the CPU 211 ends the processing illustrated in FIG. 8, and if it is determined that the event notification is other than the focus-in event notification (No), the CPU 211 proceeds to processing in S804.

In S804, the CPU 211 uses the click event notification determination unit 334 to determine whether the event notification detected in S802 is the click event notification. If it is determined that the event notification is the click event notification (Yes), the CPU 211 ends the processing illustrated in FIG. 8, and if it is determined that the event notification is other than the click event notification (No), the CPU 211 proceeds to processing in S805.

In S805, the CPU 211 uses the focus-out event notification determination unit 335 to determine whether the event notification detected in S802 is the focus-out event notification. If it is determined that the event notification is the focus-out event notification (Yes), the CPU 211 proceeds to processing in S806, and if it is determined that the event notification is other than the focus-out event notification (No), the CPU 211 ends the processing illustrated in FIG. 8. In S806, the CPU 211 uses the change event generation unit 336 to generate the change event and ends the processing illustrated in FIG. 8.

According to the present embodiment, the browser app generates the change event in a case where the received event notification is the focus-out event notification, neither the focus-in event notification nor the click event notification. Thus, with the browser app generating the change event, it is possible to obtain an effect that JavaScript corresponding to the change event is executed as with the first embodiment.

### Third Embodiment

In the present embodiment, an example in which the event handler 310 generates the change event in a case where the value is changed between before the input and after the input into the input field. Thus, it is possible to generate the change event more properly.

### Software Configuration Diagram of Image Formation Apparatus 101

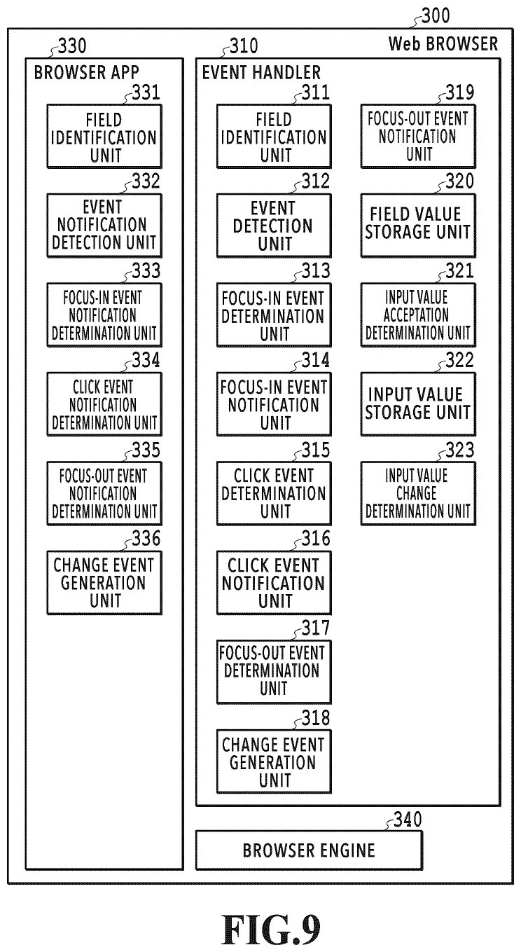

FIG. 9 is a diagram illustrating an example of a program configuration of the Web browser 300 stored in the image formation apparatus 101 in the present embodiment. FIG. 9 has a basic configuration same as that of FIG. 3; however, it is different in that some configurations are added to the event handler 310. Details of the event handler 310 are described with reference to FIG. 9. Note that, description of a configuration of the event handler 310 described in the first embodiment is omitted.

A field value storage unit 320 stores the value of the input field. An input value acceptation determination unit 321 determines whether the event detection unit 312 detects an event of accepting an input of the input value and returns a determination result. An input value storage unit 322 stores the received input value. An input value change determination unit 323 compares the value of the field value storage unit 320 to the value of the input value storage unit 322 to determine whether there is a change and returns a determination result.

### Event Notification Processing by Event Handler While Displaying Web Contents

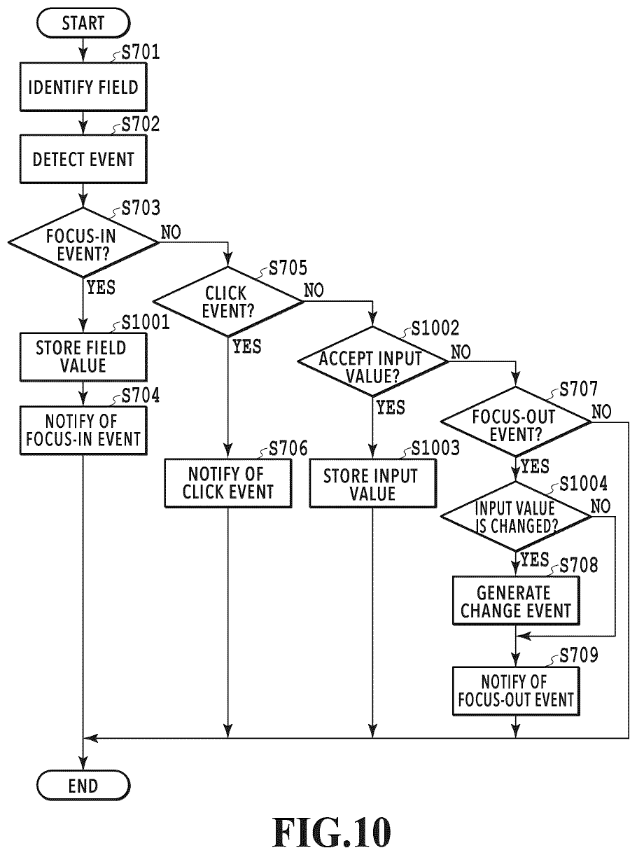

FIG. 10 is a flowchart illustrating an example of processing executed by the event handler 310. Processing in which the event handler 310 detects an event of a specific input field and notifies of the event while the browser app 330 of the image formation apparatus 101 in the present embodiment displays the Web contents is described with reference to FIG. 10. Processing from S701 to S709 illustrated in FIG. 10 is similar to the processing in a similar step number illustrated in FIG. 7; for this reason, description thereof is omitted.

In S1001, the CPU 211 uses the field value storage unit 320 to store a field value of the input field identified in S701, and the CPU 211 proceeds to processing in S704. The field value is a value indicating a character string already inputted in the input field or a value indicating that the input field is blank. Note that, although description is provided using the character string as an example as the value inputted into the input field, it may be a sign, a value such as a number, and the like.

In S1002, the CPU 211 uses the input value acceptation determination unit 321 to determine whether the event detected in S702 is the event of accepting the input of the input value. If it is determined that the event detected in S702 is the event of accepting the input of the input value (Yes), the CPU 211 proceeds to processing in S1003, and if it is determined that the event detected in S702 is an event other than the event of accepting the input of the input value (No), the CPU 211 proceeds to processing in S707.

In S1003, the CPU 211 uses the input value storage unit 322 to store the input value accepted in S1002 and ends the processing illustrated in FIG. 10. The input value is a value indicating the character string inputted by the input operation.

In S1004, the CPU 211 calls the input value change determination unit 323, compares the value stored in the field value storage unit 320 to the value stored in the input value storage unit 322, and determines whether there is a change between the two values. If it is determined that there is a change (Yes), the CPU 211 proceeds to processing in S708, and if it is determined that there is no change (No), the CPU 211 proceeds to processing in S709. Then, in a case where there is a change between the two values, in S708, using the change event generation unit 336, the CPU 211 generates the change event.

According to the present embodiment, the event handler generates the change event in a case where the detected event is the focus-out event, neither the focus-in event nor the click event, and there is a change in the input value. Thus, with the event handler generating the change event, it is possible to obtain an effect that JavaScript corresponding to the change event is executed. In addition, with the change event being generated in a case where the value is changed between before the input and after the input into the field, it is possible to obtain an effect that excessive generation of the change event is suppressed.

### Other Embodiments

In the above-described embodiments, the image formation apparatus is described as an example of an information processing apparatus connectable to a network; however, it is not limited thereto. For example, the information processing apparatus may be any apparatus as long as it is a general apparatus including a Web browser such as a desktop personal computer (PC), a laptop PC, a tablet terminal, and a television.

In the above-described embodiments, the change event is described as the processing of converting a lower case inputted in the input field into an upper case; however, it is not limited thereto. For example, the change event may be processing of converting an inputted character into a hiragana, a katakana, a kanji, or the like, processing of translation to convert an inputted character into a different language, or processing of converting an inputted character into a sign, a number, or a combination thereof. Additionally, the change event may be processing of performing opposite conversion of the above-described processing such as processing of converting an upper case into a lower case.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-008779, filed Jan. 24, 2024, which is hereby incorporated by reference herein in its entirety.

What is claimed is:

1. An information processing apparatus configured to execute a Web browser and an event handler implemented on the Web browser, the information processing apparatus comprising:
at least one memory and at least one processor which function the event handler as:
a generation unit configured to generate a change event in a case where a predetermined event is notified from a browser engine of the Web browser.

2. The information processing apparatus according to claim 1, wherein the event handler is further functioned as a notification unit configured to notify the Web browser of a predetermined event in a case where the predetermined event is notified from the browser engine.

3. The information processing apparatus according to claim 1, wherein the predetermined event is a focus-out event to focus out of an input field displayed on the Web browser in a state in which an input value is inputted in the input field.

4. The information processing apparatus according to claim 3, wherein in a case where the focus-out event is notified from the browser engine, the generation unit generates the change event.

5. The information processing apparatus according to claim 3, wherein
the event handler is further functioned as a determination unit configured to compare a value already inputted in the input field to a value inputted in the input field and determine whether there is a change, and
in a case where the determination unit determines that there is a change, the generation unit generates the change event.

6. The information processing apparatus according to claim 3, wherein the change event is an event to change a value inputted in the input field to a value different from the value.

7. The information processing apparatus according to claim 3, wherein the change event is an event to convert a lower case inputted in the input field into an upper case.

8. The information processing apparatus according to claim 1, wherein
the browser engine is configured not to generate the change event.

9. The information processing apparatus according to claim 1, wherein
the information processing apparatus is an image formation apparatus.

10. An information processing apparatus configured to execute a Web browser and a browser app implemented on the Web browser, the information processing apparatus comprising:
at least one memory and at least one processor which function the browser app as:
a generation unit configured to generate a change event in a case where a predetermined event notification is received from an event handler implemented on the Web browser.

11. A control method of an information processing apparatus configured to execute a Web browser and an event handler implemented on the Web browser, the control method comprising:
generating a change event in a case where the event handler is notified of a predetermined event from a browser engine of the Web browser.

12. A non-transitory computer readable storage medium storing a program for causing a computer to perform an information processing method as an event handler on a Web browser, the information processing method comprising the step of:
generating a change event in a case where the event handler is notified of a predetermined event from a browser engine of the Web browser.
